(19) United States
(12) Patent Application Publication
(10) Pub. No.: US 2007/0229533 A1
(43) Pub. Date: Oct. 4, 2007

(54) System and Method for Reducing Complexity in a Color Sequential Display System

(75) Inventors: Sandeep Dalal, Cortlandt Manor, NY (US); Cornelis Conradus Adrianus Maria Van Zon, Cold Spring, NY (US); Lilly Boroczky, Mount Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,131

(22) PCT Filed: Aug. 10, 2005
(86) PCT No.: PCT/IB05/52656

§ 371 Date: Feb. 2, 2007

Related U.S. Application Data
(60) Provisional application No. 60/601,444, filed on Aug. 13, 2004.

(51) Int. Cl. H04N 9/31

(52) U.S. Cl. 345/604

(57) ABSTRACT

A system and method for reducing complexity in a color sequential display system that utilizes motion compensation and color conversion. A color sequential display system (10) is provided that comprises: a motion estimation system (14) that operates on a Y component from a set of YUV components to generate a set of motion vectors (36); and a complexity reduction system (22) that receives the set of motion vectors and the set of YUV components and outputs motion compensated red, green, blue (RGB) data (38), wherein the complexity reduction system includes: a color space conversion system (18) that converts from a YUV color space to an RGB color space based on a set of conversion equations (32); and a motion compensated color sequencing system (16) that selects a subset of the YUV components to motion compensate based on the set of conversion equations.

The present invention relates generally to frame-rate upconversion for color sequential display systems, and relates more particularly to a system and method for reducing complexity by integrating motion-compensated frame rate upconversion with color space conversion.

Color image displays are of two general types. In a first type, exemplified by a typical direct view cathode ray tube color display, all color image components are displayed simultaneously. Thus, an image model, e.g., a CCIR-601 signal, defines the luminance and chrominance of each image pixel at a particular time. The motion image is therefore presented as a time sequence of color image frames.

In a second type of color image display, color image planes are displayed sequentially. This type of system is employed, for example, in certain single panel image projection systems, in which light of various colors sequentially illuminates a common spatial light modulator. The spatial light modulator, therefore, modulates the intensity of each respective color component of a pixel sequentially and independently, which is perceived as a color motion image.

Color sequential displays display the Red, Green, Blue (RGB) colors alternating during a frame period. The viewer perceives the integrated light from each pixel of the image; however, either due to saccadic motion of the eye of the viewer or due to the motion of a high-contrast object that is only partially tracked by the viewer, edges of the object may image with unintended color fringes onto different portions of the viewer's retina. This causes an artifact termed as color-breakup and, when observed, is detrimental to picture quality.

Various approaches have been suggested for addressing this problem, such as that described in PCT Publication WO 01/10131 A1, A System and Method for Motion Compensation of Image Planes in Color Sequential Displays, published on Feb. 8, 2001, which is hereby incorporated by reference. These techniques describe the use of motion estimation and motion compensation to generate the red, green and blue frames displayed on a color sequential display. Motion compensation techniques can be used to generate frames at a display frame rate that is higher than the source frame rate. The use of high display frame rates contributes significantly to a reduction in the color breakup artifact as well as a reduction in motion-judder. When motion compensated frame-rate upconversion techniques are employed, they usually involve a reduction in complexity by employing motion compensation in the luminance/chrominance (YUV) space due to a reduction in storage and bandwidth as compared to motion compensation directly in the RGB color space required by the display. However, such techniques still tend to be computationally intensive. Accordingly, a need exists for a system and method that can reduce the complexity of frame-rate upconversion that addresses the problem of color breakup artifacts caused by a sequential color display.

The present invention addresses the above-mentioned problems, as well as others by providing a system, method and program product for reducing complexity in a color sequential display system by integrating motion compensation with color conversion. In a first aspect, the invention provides a method for reducing complexity in a color sequential display system, comprising: receiving a set of color components in a first color space; generating a set of motion vectors based on at least one of the color components in the first color space; and performing a motion compensation calculation on a subset of the color components in the first color space, wherein the subset is determined based on a conversion equation that converts the set of color components in the first color space to a set of color components in a second color space.

In a second aspect, the invention provides a color sequential display system, comprising: a motion estimation system that operates on a Y component from a set of YUV components to generate a set of motion vectors; and a complexity reduction system that receives the set of motion vectors and the set of YUV components and outputs motion compensated red, green, blue (RGB) data, wherein the complexity reduction system includes: a color space conversion system that converts from a YUV color space to an RGB color space based on a set of conversion equations; and a motion compensated color sequencing system that selects a subset of the YUV components to motion compensate based on the set of conversion equations.

In a third aspect, the invention provides a program product stored on a recordable medium for reducing complexity in a color sequential display system, comprising: means for receiving a set of color components in a first color space; means for generating a set of motion vectors based on at least one of the color components in the first color space; and means for performing a motion compensation calculation on a subset of the color components in the first color space, wherein the subset is determined based on a conversion equation that converts the set of color components in the first color space to a set of color components in a second color space.

These and other features of this invention will be more readily understood from the following detailed description of the various aspects of the invention taken in conjunction with the accompanying drawings in which:

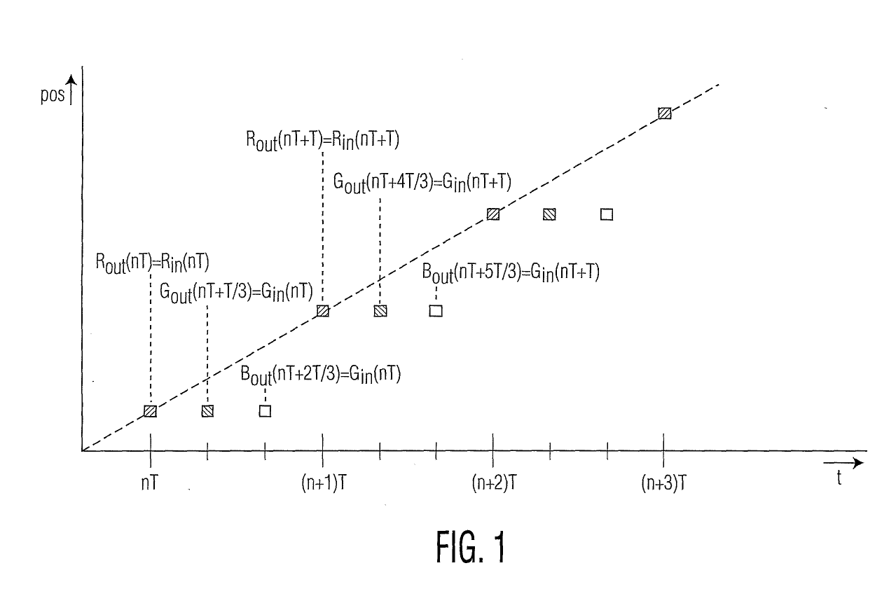

FIG. 1 depicts an RGB output for a traditional non motion-compensated color sequential display.

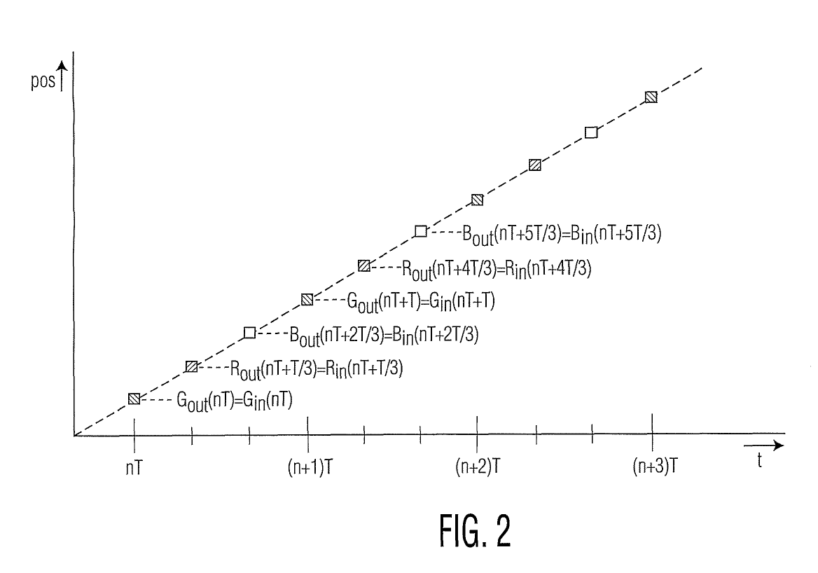

FIG. 2 depicts a motion compensated RGB output for a color sequential display.

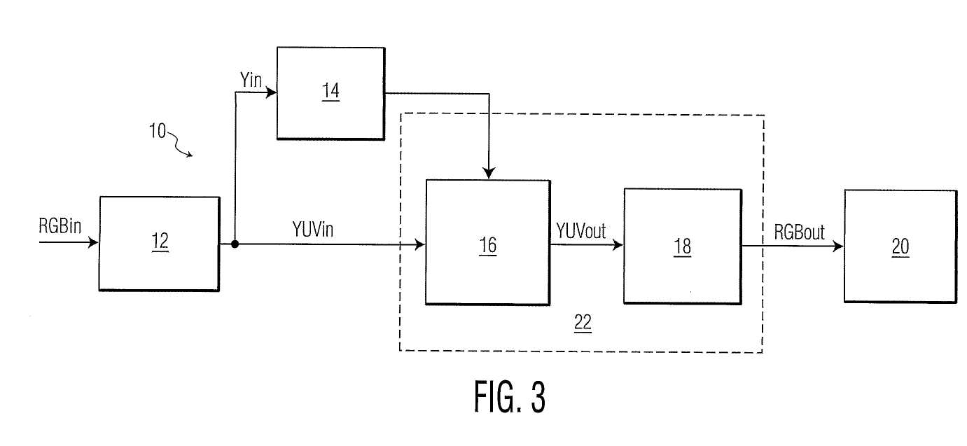

FIG. 3 depicts a color sequence processing system in accordance with the present invention.

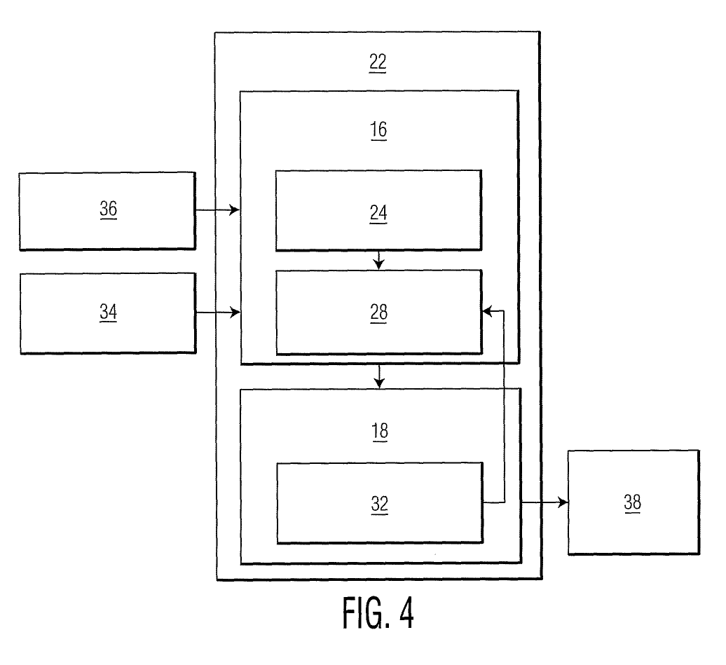

FIG. 4 depicts a complexity reduction system in accordance with the present invention.

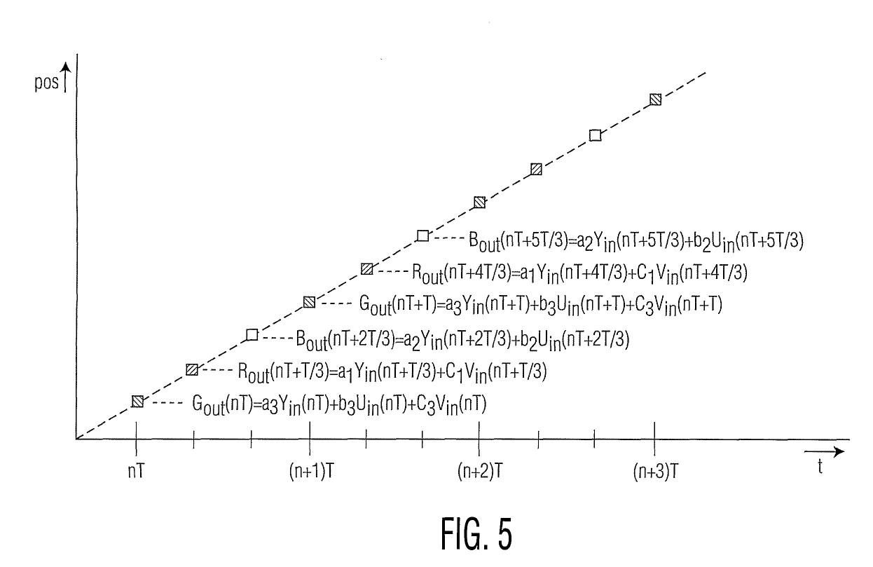

FIG. 5 depicts a motion compensated RGB output using the complexity reduction system of the present invention.

The present invention provides a system and method for reducing complexity in a color sequential display system by integrating motion-compensated frame rate upconversion with color space conversion. As described below, the necessary motion compensation calculations are made dependent on the equations used to convert between color spaces, thus allowing certain calculations to be eliminated without sacrificing performance.

Color sequential displays create full color pictures by showing their constituting Nₒᵤₜ primary color components C_{out,i}(t) in time-sequential fashion (i=1 . . . Nₒᵤₜ). These primary color components are identical to or derived from Nᵢₙ color components at the input of the display, denoted as Cᵢₙⱼ(t)(j=1 . . . Nᵢₙ). The input may be RGB, YUV or otherwise, and the output RGB or otherwise. Typically, the Nᵢₙ color components represent the same time instance of the original scene. If the Nₒᵤₜ outputs represent the same moment in time as the Nᵢₙ inputs, and they are shown in time-sequential fashion, at least Nₒᵤₜ−1 of the Nₒᵤₜ output colors will be shown at the wrong moment in time.

This effect, which causes a visible artifact called motion judder, is illustrated in FIG. 1 for Nₒᵤₜ=Nᵢₙ−3 with RGB input and RGB output. FIG. 1 depicts the position of an object that moves on a trajectory termed as the “original motion” trajectory, but is rendered by a color sequential display at different instances in time at the positions shown in the respective colors. Time instances nT, (n+1)T, etc., indicate the instances of validity of the input components, with T being the input frame period; and the y-axis being the position of the moving object. As can be seen, the red component Rₒᵤₜ(t) is displayed at the correct position along the “original motion” trajectory; however the green and blue color components Gₒᵤₜ(t) and Bₒᵤₜ(t) are displayed at the wrong positions as compared to the “original motion” trajectory. The viewer will see this as a disturbance in the natural motion trajectory of the object which leads to motion judder.

Better results can be obtained by applying motion-compensated frame rate conversion, which calculates the output components for the proper display time instance by motion-compensated interpolation between input frames. Observing that the motion estimation and motion compensated interpolation procedures introduce errors, it is furthermore claimed that it is advantageous to take the primary color component that contributes most to the perceived brightness (e.g., green) as a time reference, and interpolate only the red and blue colors.

FIG. 2 shows how full motion compensation leads to better tracking of the original motion. In this case, the color components for red and blue are obtained by motion-compensated interpolation. In order to save complexity, the motion vectors may only be obtained for the time instance of the “second-brightest” color component (e.g., red), allowing the “least-brightest” color(s) to be displayed at the wrong time instance at the cost of some residual judder. In order to save even further on complexity, motion estimation and compensation could be done in a different color space (e.g., YUV), in order to benefit from the lower bandwidth of U and V. If residual judder is allowed, U and V motion compensation can even be omitted.

Motion compensation in the YUV color space benefits from the reduction in storage and (concomitantly) bandwidth of the U and V color components as compared to R, G, and B color components. Very high quality is achieved with a 4:2:2 YUV sampling format in which the U and V components each have half the bandwidth of the Y component. The Y component has the same bandwidth as the R, G, and B components. Alternately, one could use other YUV sampling formats, for example YUV 4:2:0, in which the U and V components have a quarter of the bandwidth of the Y component.

FIG. 3 depicts an illustrative color sequence processing system 10. If YUV video inputs are not already available in the system, RGB or other color space video inputs are converted to, e.g., 4:2:2 YUV color components, by color space conversion 12. Motion estimation 14 is then performed on the Y input component to calculate motion vectors for the U and V components. The estimated motion vectors are then used by motion compensated color sequencing system 16 to derive motion compensated Y, U, and V output components for the correct display instance. YUV 4:2:2 provides a 33% and YUV 4:2:0 provides a 50% reduction in the amount of data that needs to be processed if the Y, U, and V components are first motion compensated to the correct display time instance, as compared to motion compensating each of the R, G or B components individually in the RGB color space. Following this, the motion compensated R, G, and B components are calculated by color space conversion system 18 using a standard color space conversion method. The outputted RGB signal is then sent to a color sequential display 20.

The present invention includes a complexity reduction system 22, which integrates the functionality of the motion compensated color sequencing system 16 with the color space conversion system 18. In particular, the present invention recognizes that the color space conversion system 18 may not need both the U and V components to calculate the R, G, or B motion compensated output to be sent to the display 20. Thus, the U and V motion compensated components need not be calculated at every display time instance.

FIG. 4 depicts complexity reduction system 22 in more detail. Complexity reduction system 22 provides the functionality that allows motion compensated color sequencing system 16 to process U and V components differently depending upon which of the R, G, or B color components needs to be displayed at the output. In particular, motion compensated color sequencing system 16 includes an output color identification system 24, which identifies which of the R, G, or B color components is to be displayed at the output at a particular temporal instance for a given YUV input. Identifying the color component that is to be displayed can be readily determined, for instance, based on the time sequencing of the color data being processed. For instance, as shown in FIG. 2, it is known that the output components are displayed in the order GRB, GRB, GRB, etc. Moreover, it is known that the green component Gₒᵤₜ(t) is displayed at the start of each frame; the red component Rₒᵤₜ(t) is displayed ⅓ of the way into each respective frame (e.g., nT+T/3, nT+4T/3, etc.); and the blue component Bₒᵤₜ(t) is displayed ⅔ of the way into each respective frame. Accordingly, output color identification system 24 can readily track which output color is being displayed for a given YUV input.

Once the particular color component being processed for output is determined, input component selection system 28 will select which of the inputted components need to be included in the motion compensation calculations. This determination is based on the conversion equation set 32 that is utilized to convert the inputted color components (e.g., YUV) to the outputted color components (e.g., RGB) 38.

For instance, in the system of FIG. 3, the input to the complexity reduction system 22 comprises Y, U and V components and the output comprises R, G and B components. According to ITU recommendations ITU-R 601 [3] (or ITU-709 [4]), R, G and B can be written as the following conversion equation set 32 (with offsets ignored):
R=a1×Y+c1×V
B=a2×Y+b2×U
G=a3×Y+b3×U+c3×V,

wherein a1, a2, a3, b2, b3, c1 and c3 comprise conversion coefficients.

Thus, for the temporal instance that R is to be displayed, only the Y and the V components are selected by input component selection system 28 to be calculated in a motion-compensated fashion. Similarly, for the temporal instance that B is to be displayed, only the Y and the U components are selected by input component selection system 28 to be calculated in a motion-compensated fashion.

This is shown in more detail in FIG. 5. If the display time instance of the G component coincides with the input time instance of the YUV input, no motion compensation is required for any of the Y, U or V components at such display time instances (since G is established as the time reference). If the display time instance of the B component coincides with the input time instance of the YUV input, then no motion compensation is required for the Y and the U component at that instance. Finally, if the display time instance of the R component coincides with the input time instance of the YUV input, then no motion compensation is required for the Y and the V component at that instance. This is to be compared to a YUV motion compensation system that automatically calculates the motion compensated Y, U and V components at all display time instances, regardless of the need for some of those components. Thus, the overall complexity of the motion compensation color sequencing system 16 is significantly reduced without any sacrifice to performance.

While the invention has been described above with reference to a system that converts YUV to RGB, it should be understood that the concept is not limited to YUV/RGB color spaces, and can be applied to any system that includes (1) motion compensation for color sequencing, (2) color conversion, and (3) foreknowledge of the display's time sequential ordering of the color components. Moreover, the invention may be generalized to multi-primary displays (e.g., N out >3) in which one output component is derived from a subset of the input components. In such cases, the relationship between the inputted (e.g., YUV) components and the output components may not be uniquely defined. The conversion equation set 32 could therefore be chosen such that the number of conversions on U and V is minimized.

In a general example involving a linear relationship between the input and output components, each of the Nₒᵤₜ primary output colors C_{out,i}(i=1 . . . Nout) could be written as:
C_{out,i}=αi×Y+βi×U+γi×V, for i=1 to Nₒᵤₜ.

For those output colors i for which γi is zero or small (i.e., less than some predetermined threshold), U need not be upconverted. Likewise, V need not be upconverted for those colors in which γi is zero or small. Note that the conversion equation set need not be limited to linear relationships, but rather may involve any relationship. Moreover, as noted, this idea can be extended to using color spaces other than YUV for motion compensation.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for reducing complexity in a color sequential display system, comprising:
receiving a set of color components (34) in a first color space;
generating a set of motion vectors (36) based on at least one of the color components in the first color space; and
performing a motion compensation calculation on a subset of the color components in the first color space, wherein the subset is determined based on a conversion equation (32) that converts the set of color components in the first color space to a set of color components in a second color space.

2. The method of claim 1, comprising the further step of sequentially displaying the set of color components in the second color space.

3. The method of claim 1, wherein the set of color components in the first color space is color converted from the set of color components in the second color space.

4. The method of claim 1, wherein the second color space comprises a red, green, blue (RGB) color space.

5. The method of claim 4, wherein the first color space comprises a YUV color space.

6. The method of claim 5, wherein the conversion equation is selected from the equations consisting of:
R=a1×Y+c1×V
B=a2×Y+b2×U
G=a3×Y+b3×U+c3×V,
wherein a1, a2, a3, b2, b3, c1 and c3 comprise predetermined conversion coefficients.

7. The method of claim 6, wherein at least one of the color components in the first color space is a Y component.

8. The method of claim 7, wherein the subset consists of a Y and U component if the conversion equation for converting to the RGB color space is for a blue output component, and consists of a Y and V component if the conversion equation for converting to the RGB color space is for a red output component.

9. The method of claim 1, wherein the conversion equation is defined as:
C_{out,i}=αi×Y+βi×U+γi×V, for i=1 to Nₒᵤₜ,
wherein C_{out,i} is the ith output color component, and Nₒᵤₜ is the number of output color components, and wherein motion compensation is not performed on U if βi is less than or equal to a first predetermined threshold and motion compensation is not performed on V if γi is less than or equal to a second predetermined threshold.

10. A color sequential display system (10), comprising:
a motion estimation system (14) that operates on a Y component from a set of YUV components (34) to generate a set of motion vectors (36); and
a complexity reduction system (22) that receives the set of motion vectors and the set of YUV components and outputs motion compensated red, green, blue (RGB) data (36), wherein the complexity reduction system includes:
a color space conversion system (18) that converts from a YUV color space to an RGB color space based on a set of conversion equations (32); and
a motion compensated color sequencing system (16) that selects a subset of the YUV components to motion compensate based on the set of conversion equations.

11. The color sequential display system of claim 10, further comprising a color space conversion system that initially converts RGB data to the set of YUV components.

12. The color sequential display system of claim 10, wherein the conversion equations comprise:
R=a1×Y+c1×V
B=a2×Y+b2×U
G=a3×Y+b3×U+c3×V, wherein a1, a2, a3, b2, b3, c1 and c3 comprise predetermined conversion coefficients.

13. The color sequential display system of claim 12, wherein only the Y and U components are motion compensated if a blue output is to be displayed, and only the Y and V components are motion compensated if a red output is to be displayed.

14. A program product stored on a recordable medium for reducing complexity in a color sequential display system, comprising:
means for receiving a set of color components (34) in a first color space;
means for generating a set of motion vectors (36) based on at least one of the color components in the first color space; and
means for performing a motion compensation calculation (16) on a subset of the color components in the first color space, wherein the subset is determined based on a conversion equation (32) that converts the set of color components in the first color space to a set of color components in a second color space.

15. The program product of claim 14, further comprising means for sequentially displaying the set of color components in the second color space.

16. The program product of claim 14, further comprising means for color converting the set of color components in the second color space to the set of color components in the first color space.

17. The program product of claim 14, wherein the second color space comprises a red, green, blue (RGB) color space, and the first color space comprises a YUV color space.

18. The program product of claim 17, wherein the conversion equation is selected from the equations consisting of:
R=a1×Y+c1×V
B=a2×Y+b2×U
G=a3×Y+b3×U+c3×V, wherein a1, a2, a3, b2, b3, c1 and c3 comprise predetermined conversion coefficients.

19. The program product of claim 18, wherein the subset consists of a Y and U component if the conversion equation for converting to the RGB color space is for a blue output, and consists of a Y and V component if the conversion equation for converting to the RGB color space is for a red output.

20. The program product of claim 14, wherein the conversion equation is defined as:
C_{out,i}=αi×Y+βi×U+γi×V, for i=1 to Nₒᵤₜ,
wherein C_{out,i} is the ith output color component, and Nₒᵤₜ is the number of output color components, and wherein motion compensation is not performed on U if βi is less than or equal to a first predetermined threshold and motion compensation is not performed on V if γi is less than or equal to a second predetermined threshold.
